(19) United States
(12) Patent Application Publication
(10) Pub. No.: US 2010/0259176 A1
(43) Pub. Date: Oct. 14, 2010

(54) HELIUM BALLOON

(76) Inventor: TSENG-YI LIN, Taipei (TW)

Correspondence Address: LIN TSENG-YI, P.O.BOX 46-563 Taipei, Taipei City 10499, Taipei, 104, TW

(21) Appl. No.: 12/792,732

(22) Filed: Jun. 3, 2010

(30) Foreign Application Priority Data
Apr. 14, 2009 (TW) 098206118

(51) Int. Cl. H05B 37/02

(52) U.S. Cl. 315/159

(57) ABSTRACT

A helium balloon includes a bag-shaped body, a heat dissipating lamp holder, at least one fixing ring and a sensor device. LED elements are settled inside the bag-shaped body through the heat dissipating lamp holder so that when the LED elements emit light, the entire bag-shaped body illuminates. Heat sinks at a bottom of the heat dissipating lamp holder serve to dissipate heat generated by the LED elements so as to achieve heat dissipation.

### BACKGROUND OF THE INVENTION

1. Technical Field

The present invention relates to helium balloons, and more particularly, to a helium balloon having an improved structure.

2. Description of Related Art

Balloons are light to stay up in the air and usually used by people in occasions to create joyful ambiance. In addition to this most common usage, balloons are sometimes used for advertising. FIG. 1 and FIG. 2 depict a conventional helium balloon 1, which has its bag-shaped body 10 filled with helium gas through a gas inlet 11 at the bottom of the bag-shaped body 10, and thereby floats in the air. Furthermore, for the purposes of use at night and enhanced eye-catching effects, the bag-shaped body 10 is generally provided therein with a light bulb 12, so that the entire helium balloon 1 can present an illuminative or blinking appearance. However, such a gas inlet 11 of the bag-shaped body 10 has to be tied closely by additional fasteners after the bag-shaped body 10 is filled with helium gas, and even doing so, the gas inlet 11 tends to lose its air-tight condition after a long term of use and have gas leakage. Refilling helium gas thus needs to be performed again and again. Moreover, the traditional light bulb 12 can give high heat while emitting light. Consequently, the bag-shaped body 10 may be gradually damaged by such heat. Besides, the light bulb 12 also has the problems of high power consumption and heavy weight.

Hence, how to solve the problems of the prior art is exactly the consideration of the present inventor.

### SUMMARY OF THE INVENTION

A first objective of the present invention is to provide a helium balloon that includes a bag-shaped body, a heat dissipating lamp holder, at least one fixing ring and a sensor device. LED elements are settled inside the bag-shaped body through the heat dissipating lamp holder so that when the LED elements emit light, the entire bag-shaped body illuminates. The sensor device senses the ambient light conditions and accordingly turns on or off the LED element.

A second objective of the present invention is to provide the helium balloon wherein a plurality of heat sinks are provided at a bottom of the heat dissipating lamp holder so that heat generated by the LED elements can be dissipated, thereby improving the service life of the LED element.

A third objective of the present invention is to provide the helium balloon wherein light-emitting diodes are used the light source, so that the LED elements have a relatively light overall weight that facilitates the flotation of the bag-shaped body while the light-emitting diodes are also advantaged by the low-temperature illumination and low power consumption.

### BRIEF DESCRIPTION OF THE DRAWINGS

The invention as well as a preferred mode of use, further objectives and advantages thereof will be best understood by reference to the following detailed description of illustrative embodiments when acquire in conjunction with the accompanying drawings, wherein:

FIG. 1 is a perspective view of a conventional helium balloon;

FIG. 2 is a see-through view of the conventional helium balloon;

FIG. 3 is a perspective view of a helium balloon of the present invention;

FIG. 4 is a partial schematic drawing of the present invention;

FIG. 5 is another partial schematic drawing of the present invention; and

FIGS. 6 and 7 provide more embodiments of the present invention.

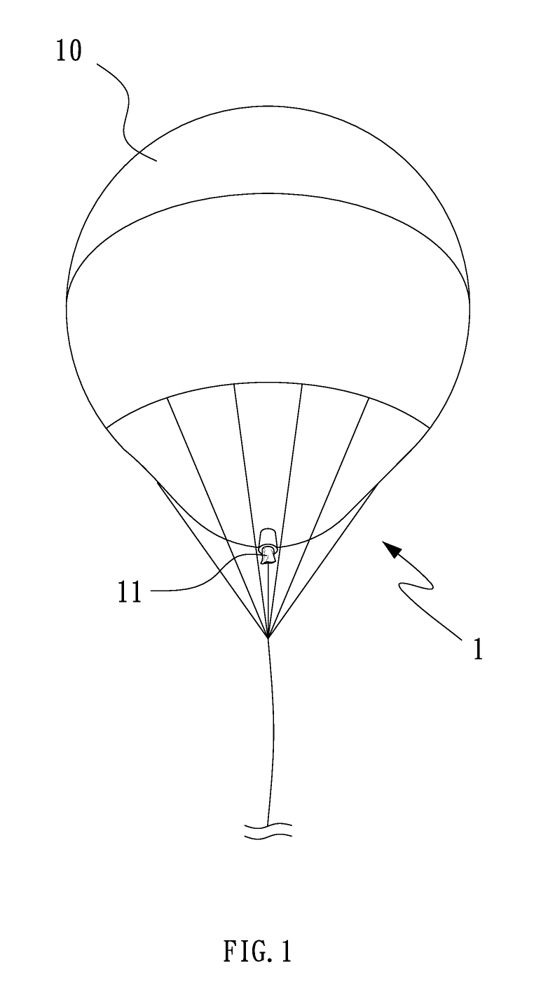

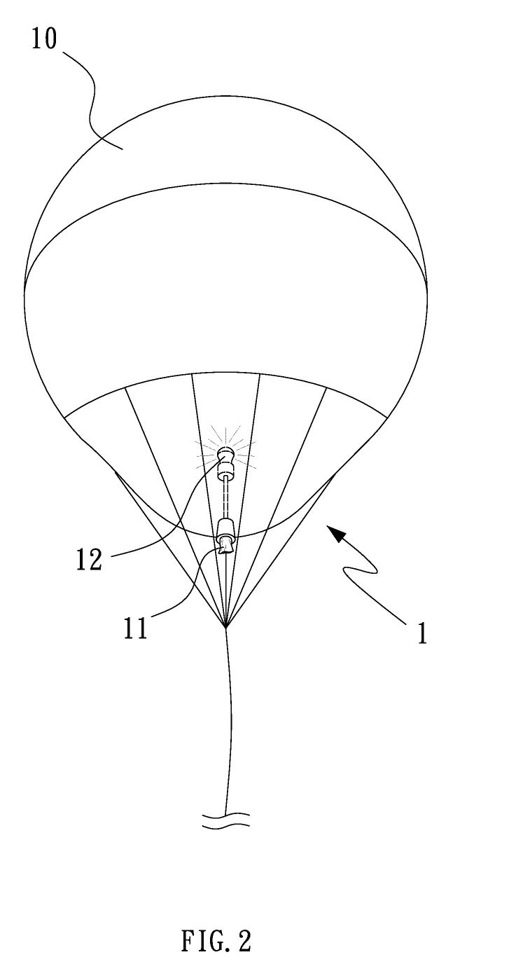

### DETAILED DESCRIPTION OF THE INVENTION

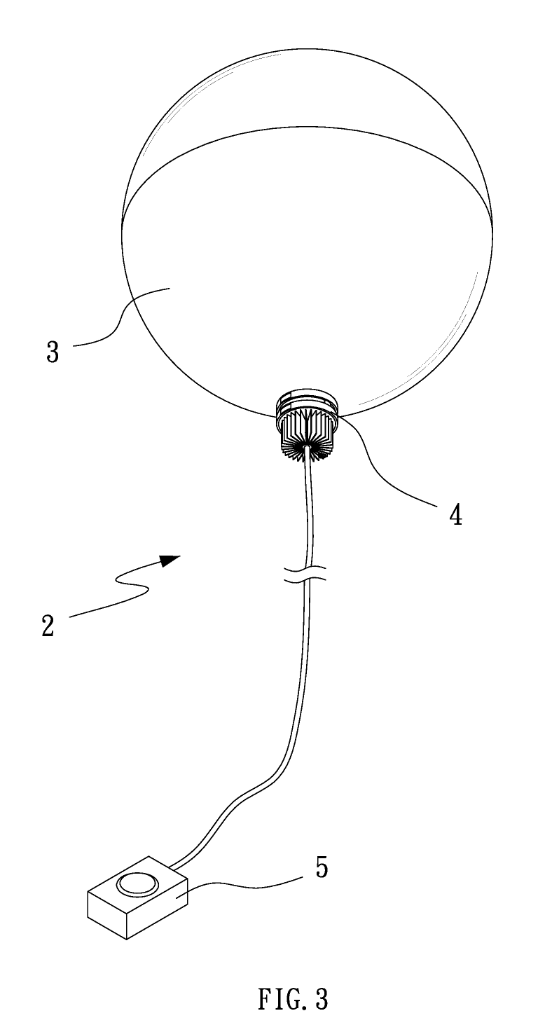

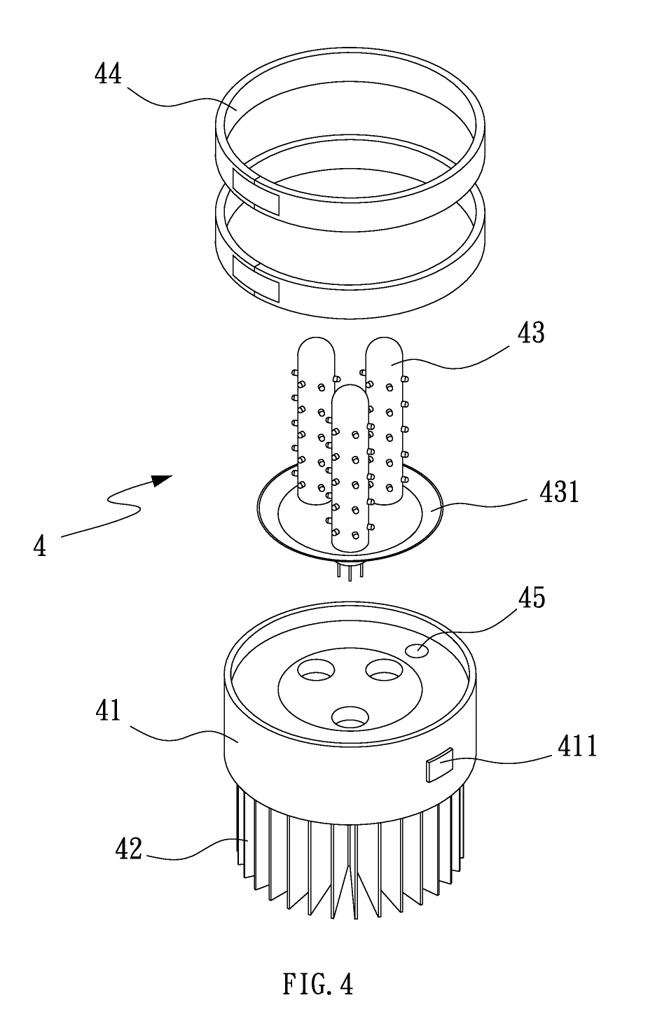

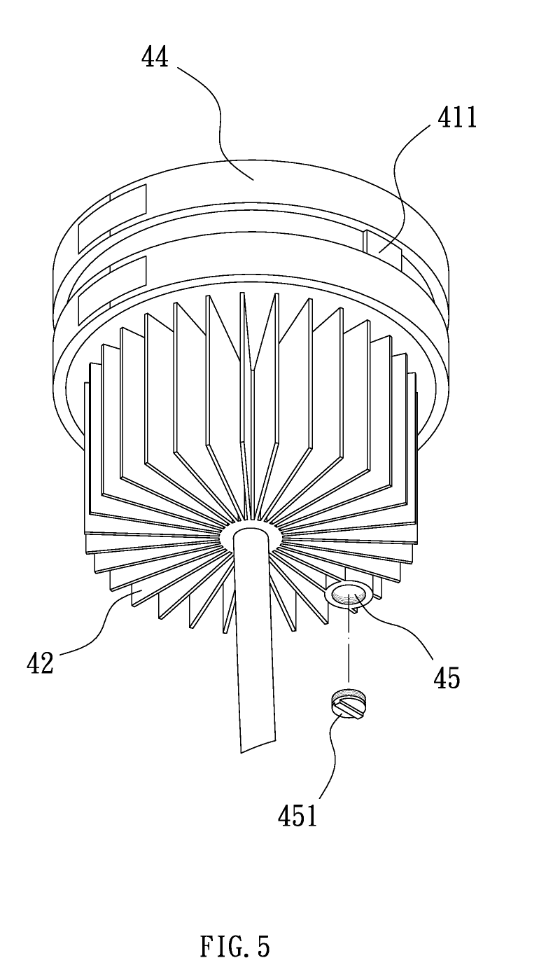

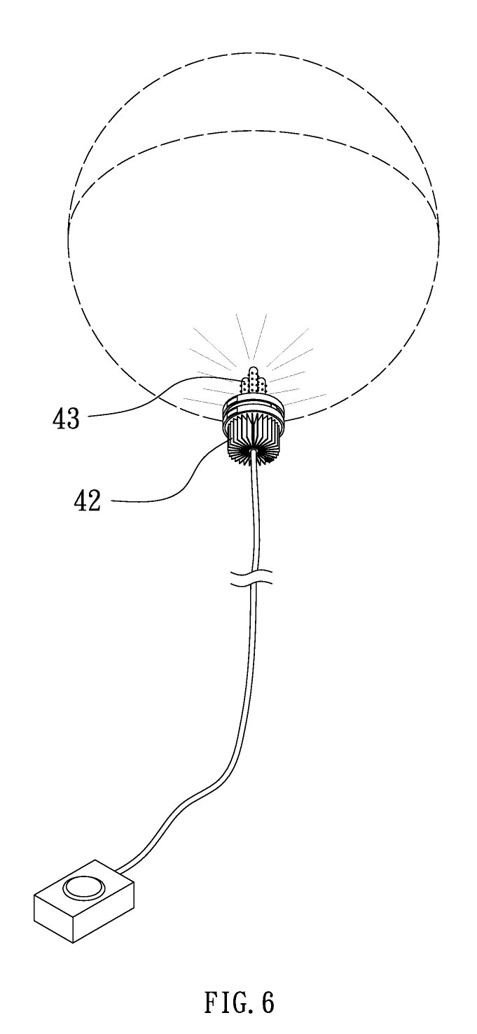

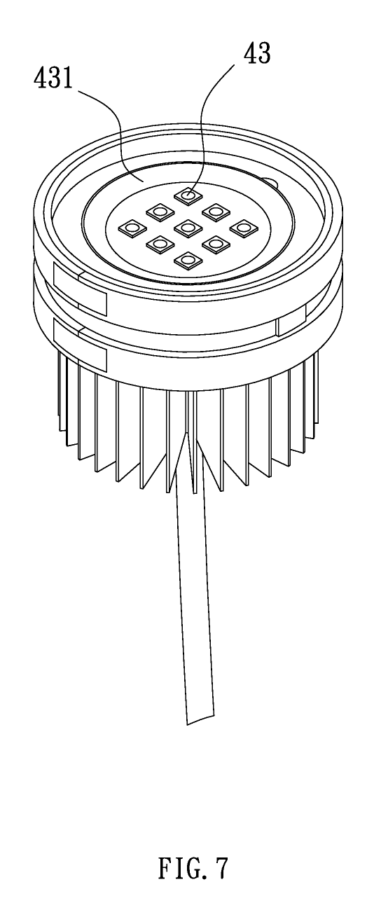

Please refer to FIGS. 3, 4, 5 and 6 for a perspective view and a partially see-through view of a helium balloon 2 according to the present invention. As shown clearly in the drawings, the helium balloon 2 is mainly composed of a bag-shaped body 3, a heat dissipating lamp holder 4, at least one fixing ring 44 and a sensor device 5.

The bag-shaped body 3 is filled with helium gas.

The heat dissipating lamp holder 4 is deposited at a bottom of the bag-shaped body 3. The heat dissipating lamp holder 4 is primarily composed of a base 41 and a plurality of heat sinks 42. On the heat dissipating lamp holder 4, there are a plurality of LED elements 43 mounted. On the heat dissipating lamp holder 4, there is further a power switch 411, a reflector 431 and an air vent 45 that is removably covered by a plug 451.

The fixing ring 44 serves to fix the heat dissipating lamp holder 4 to the bottom of the bag-shaped body 3.

The sensor device 5 is an optical sensor and separately arranged at a remote site without contacting the bag-shaped body 3 and is electrically connected with the heat dissipating lamp holder 4.

Before use, the heat dissipating lamp holder 4 is fixed to an opening of the bag-shaped body 3 by means of the fixing ring 44 and helium is filled into the bag-shaped body 3 through the air vent 45 on the heat dissipating lamp holder 4 so that the buoyancy of the helium gas floats the bag-shaped body 3 in the air. The LED elements 43 settled inside the bag-shaped body 3 is configured to be turned on or off by the sensor device 5 according to the ambient light conditions sensed by the sensor device 5. When the LED elements 43 on the heat dissipating lamp holder 4 are turned on, in virtue of the reflective effect provided by the reflector 431, the entire bag-shaped body 3 illuminates. At this time, patterns or characters that may be premade on an external surface of the bag-shaped body 3 can work with the light emitted to give enhanced advertising effects.

Therein, each of the LED elements 43 has light-emitting diodes distributed peripherally so as to provide multi-angle illustration. The LED elements 43 may be configured to present single color, dual colors or multiple colors, thereby allowing the helium balloon 2 to present changeable visual effects. The plural heat sinks 42 at the bottom of the heat dissipating lamp holder 4 serve to dissipate heat generated by the LED elements 43 so as to achieve heat dissipation.

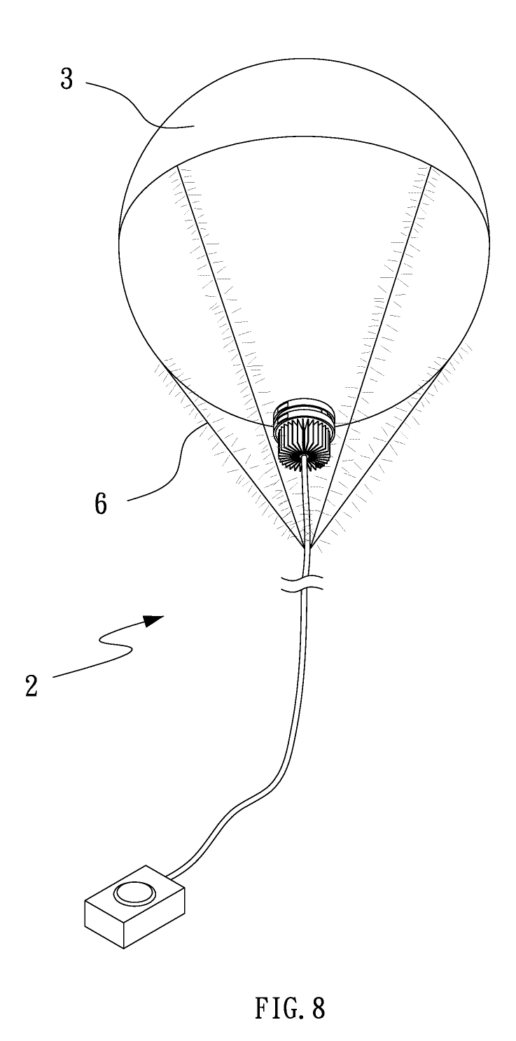

Please refer to FIGS. 7 and 8 for more embodiments of the present invention. As shown clearly in the drawing, the LED elements 43 may alternatively be high power flat LEDs whose light is reflected by a reflector 431. In addition, there may be flexible lighting strips 6 attached outside the bag-shaped body 3 for further enhancing the overall advertising effects of the helium balloon 2.

In virtue of the above-mentioned structure, the helium balloon of the present invention is superior to the prior art by the following advantages:
1. The present invention implements the heat sinks 42 at the bottom of the heat dissipating lamp holder 4 to dissipate heat generated by the LED elements 43 so as to prevent the bag-shaped body 3 from being damaged by high heat, thereby improving the service life of the bag-shaped body 3. In addition, since the overall weight of the LED elements 43 is smaller than that of the conventionally used light bulbs, the bag-shaped body 3 can float in the air with a lighter burden.
2. The sensor device 5 arranged outside the bag-shaped body 3 and connected with the LED elements 43 serves to sense the ambient light conditions and accordingly turns on or off the LED elements 4.
3. The air vent 45 on the dissipating lamp holder 4 of the present invention allows easy filling of helium gas and needs not to be tied by additional components after the bag-shaped body 3 is properly filled. It also facilitates effectively maintaining the gas-filled bag-shaped body airtight in long term respect.

What is claimed is:

1. A helium balloon comprising:
a bag-shaped body filled with helium gas;
a heat dissipating lamp holder deposited at a bottom of the bag-shaped body, the heat dissipating lamp holder having a base and a plurality of heat sinks provided at a bottom of the base and a plurality of LED elements being mounted on the heat dissipating lamp holder;
at least one fixing ring for fixing the heat dissipating lamp holder to the bottom of the bag-shaped body; and
a sensor device arranged outside the bag-shaped body and electrically connected with the heat dissipating lamp holder;
thereby the LED elements on the heat dissipating lamp holder making the entire bag-shaped body illuminate, and the heat sinks at the bottom of the heat dissipating lamp holder dissipating heat generated by the LED elements and the sensor device sensing ambient light conditions to accordingly turn on or off the LED elements.

2. The helium balloon of claim 1, wherein the LED elements are configured to present single color, dual colors or multiple colors.

3. The helium balloon of claim 1, wherein each of the LED elements has a plurality of light-emitting diodes distributed peripherally.

4. The helium balloon of claim 1, wherein a reflector is provided on the heat dissipating lamp holder for reflecting light emitted by the LED elements.

5. The helium balloon of claim 1, wherein an air vent is provided on the heat dissipating lamp holder.

6. The helium balloon of claim 1, wherein the sensor device is an optical sensor.
